(19) United States
(12) Patent Application Publication
(10) Pub. No.: US 2023/0062407 A1
(43) Pub. Date: Mar. 2, 2023

(54) GOLF PUTTER SHAFT

(71) Applicant: LA Golf Partners LLC, Newport Beach, CA (US)

(72) Inventor: Jeffrey William MEYER, San Diego, CA (US)

(21) Appl. No.: 17/412,073

(22) Filed: Aug. 25, 2021

(51) Int. Cl. A63B 53/10; A63B 53/00

(52) U.S. Cl. CPC A63B 53/10; A63B 53/002; A63B 53/007

(57) ABSTRACT

A golf putter has a shaft of composite materials, a putter head having a stud for mounting to the shaft of composite materials, and a grip affixed to the shaft. The shaft is a hollow shaft and the surface is sanded and cleaned before a first layer of pre-preg material is rolled onto the shaft and secured with an adhesive layer. At least one additional layer of the pre-preg material is rolled onto the first layer of the pre-preg material and secured using adhesive. Additional layers of pre-preg material may be applied to the hollow shaft. Cellophane is wrapped on top of the at least one layer of the pre-preg material prior to heat curing of the hollow shaft. After heat curing, the cellophane is removed and the surface is sanded and decorated.

### FIELD OF THE DISCLOSURE

Aspects of the present disclosure generally relate to golf putters, and more particularly to techniques and apparatuses for improved golf putter shafts.

### BACKGROUND

A putter is a club used in the sport of golf to make relatively short and low-speed strokes to roll a golf ball into a cup (e.g., a cylindrical hole) from a short distance, which is referred to as putting a golf ball. A putter is distinguished from other golf clubs, such as irons, woods, and wedges, by having a club head with a very flat, low-profile and low-loft striking face. Putters may have other features, such as bent shafts, non-circular grips, and positional guides, which are not allowed on other clubs.

Putters are generally used very close to the cup, most often on a putting green. In some cases, putters may be used from the fringes or roughs near the green that may also be suitable for putting. While the rules of golf specify the maximum number of clubs a player may carry and do not specify a particular club, the putter is a club used by nearly every golfer. In particular, putters are specialized clubs for a specific task and nearly every golfer has one in their bag of clubs.

Golf clubs, including putters, have shafts with a grip and a club head. The shaft may be a tapered tube made of metal, such as steel, or carbon fiber composite, known as graphite. Shafts may range in diameter from 0.5 inches near the grip end and from 34 to 48 inches in length. Shafts may weigh from 1.6 to 6.5 ounces, depending on material and length. The shaft is a key component of the modem golf club and works in conjunction with the club head during the golfer’s swing. Shafts may be given a flex rating that allows a player to select a shaft with the desired properties specified to produce a better game. The flex rating may help a player determine specific criteria specified to launch the ball higher, or lower, and adjust the timing of a player’s swing to load and unload the shaft at the precise moment specified for maximum power. These characteristics may also be incorporated into putters.

There is a desire in the art for a multi-material shaft for putters that allows for a wider range of shaft tip inside diameters. A completely composite shaft for a shaft over hosel application is challenging due to the thin wall thickness required to make the club look aesthetically pleasing. In addition, there is a desire to incorporate a core made from a homogeneous material in selected sections of the shaft along with viscoelastic materials to provide a finished shaft with a thin wall thickness and the required durability.

### SUMMARY

Aspects of the disclosure provide a golf club shaft that has a hollow shaft with a sanded and cleaned surface. The sanded and clean surface has a first layer of a pre-preg material rolled onto the hollow shaft. The pre-preg material is secured to the hollow shaft using an adhesive layer. At least one additional layer of the pre-preg material may be rolled onto the first layer of the pre-preg material on the hollow shaft and secured to the hollow shaft using the adhesive layer.

An additional aspect of the disclosure provides a method of manufacturing a golf club shaft. The method comprises: preparing a surface of a hollow shaft; applying a layer of an adhesive to the surface of the hollow shaft; rolling a first layer of a pre-preg material onto the surface of the hollow shaft; applying an additional layer of the adhesive to the surface of the first layer of the pre-preg material; rolling at least one additional layer of the pre-preg material onto the surface of the first layer of the pre-preg material; wrapping a cellophane layer on top of the at least one additional layer of the pre-preg material; heat curing the hollow shaft; removing the cellophane layer; sanding the surface of the hollow shaft after the heat curing; and decorating the surface of the hollow shaft after the sanding.

A further aspect of the disclosure provides a putter. The putter has a shaft of composite materials, a putter head having a stud for mounting to the shaft of composite materials, and a grip affixed to the shaft of composite materials.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating a putter fabricated, in accordance with various aspects of the present disclosure.

FIG. 2A illustrates shaft fabrication, in accordance with various aspects of the present disclosure.

FIG. 2B illustrates further shaft fabrication, in accordance with various aspects of the present disclosure.

FIG. 3A depicts further shaft fabrication, in accordance with various aspects of the present disclosure.

FIG. 3B depicts further shaft fabrication, in accordance with various aspects of the present disclosure.

FIG. 4A illustrates further shaft fabrication, in accordance with various aspects of the present disclosure.

FIG. 4B illustrates further shaft fabrication, in accordance with various aspects of the present disclosure.

FIG. 5 shows a cross-section of a putter shaft, in accordance with various aspects of the present disclosure.

FIG. 6A depicts fabrication of shaft modifications, in accordance with various aspects of the present disclosure.

FIG. 6B depicts fabrication of shaft modifications, in accordance with various aspects of the present disclosure.

FIG. 7 is a flow diagram illustrating a method of fabricating a putter shaft, in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure disclosed, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Putting is the most precise aspect of golf. The putter is designed to give a golfer every technical advantage, including a smooth stroke, good glide, smooth impact, and a bounce-free topspin launch of the ball. In addition, the putter should be fit to the individual golfer with respect to shaft angle and length.

All golf clubs share basic characteristics and the differences between various clubs of similar type is the loft, or the angle, between the club face and the vertical plane. Loft is the primary determinant of the ascending trajectory of the ball, with the tangential angle of the club head swing arc at ball impact is secondary. The impact of the club compresses the ball and grooves on the club face impart backspin to the ball. The compression and backspin create lift.

Putters are a special class of clubs with a loft that may not exceed ten degrees. They are designed to roll the ball along grass, generally from a point on the green to the hole. Putters do have loft, which may be five degrees from perpendicular at impact. This loft assists in lifting the ball from any indentation the ball may have made in the grass. In addition, putters may include grooves on the face to encourage rolling rather than skidding at impact. These grooves may increase rolling distance and may reduce bouncing over the turf.

While putters share characteristics with other golf clubs, they are unique in other ways. Putters are the only clubs that may have two striking faces, non-circular grip cross-sections, bent shafts or hosels, and aim assisting appendages. The hosel is the portion of the club head to which the shaft attaches. Hosels are integral to the balance feel and power of the club, including putters.

Hosels may feature in putter construction in several ways. Three tip geometries may be used for putter shafts: a straight shaft where the tip of the shaft is epoxied into a hosel, bent tip shafts, and putter heads where the shaft is epoxied over the top of a stud, or, a shaft over hosel design.

The disclosure provides a golf club shaft that comprises a hollow shaft. The hollow shaft includes a sanded and cleaned surface. The hollow shaft has a first layer of a pre-preg material rolled onto the hollow shaft and secured to the hollow shaft using an adhesive layer. At least one additional layer of the pre-preg material may be rolled onto the first layer of the pre-preg material on the hollow shaft and secured to the hollow shaft using the adhesive layer. The golf club shaft may have a hollow shaft comprising a homogeneous material, which may be: steel, titanium, aluminum, and magnesium. The golf club shaft may have an adhesive layer and the first layer of the pre-preg material of similar thickness and may have one to ten layers of the pre-preg material applied to the hollow shaft. The hollow shaft may have a tip inside diameter ranging between 0.300 inches and 0.500 inches and may have a thickness between 0.0001 inches and 0.0200 inches.

The disclosure provides a method of manufacturing a golf club shaft. The method comprises: preparing a surface of a hollow shaft and then applying a layer of an adhesive to the surface of the hollow shaft. A first layer of a pre-preg material is then rolled onto the surface of the hollow shaft. An additional layer of the adhesive may then be applied to the surface of the first layer of the pre-preg material. At least one additional layer of the pre-preg material is then rolled onto the surface of the first layer of the pre-preg material. A cellophane layer is then wrapped on top of the at least one additional layer of the pre-preg material. The hollow shaft is then heat cured and the cellophane layer removed. The surface of the hollow shaft is sanded after the heat curing, at which time the surface of the hollow shaft may be decorated. When additional layers are applied the adhesive is applied to the at least one layer of the pre-preg material. Up to ten layer of the pre-preg material may be applied. The pre-preg material may comprise carbon fiber and the adhesive may be a viscoelastic material. In addition, the pre-preg material may comprise pre-impregnated fibers and a partially cured polymer matrix. The matrix material may be one of thermoset or thermoplastic resin. The pre-impregnated fibers may be unidirectional or woven.

The disclosure also provides a putter comprising a shaft of composite materials, a putter head having a stud for mounting to the shaft of composite materials, and a grip affixed to the shaft of composite materials. The putter may also have a steel tip as part of the shaft of composite materials. The shaft may also have a steel mid-section coupled with the composite materials.

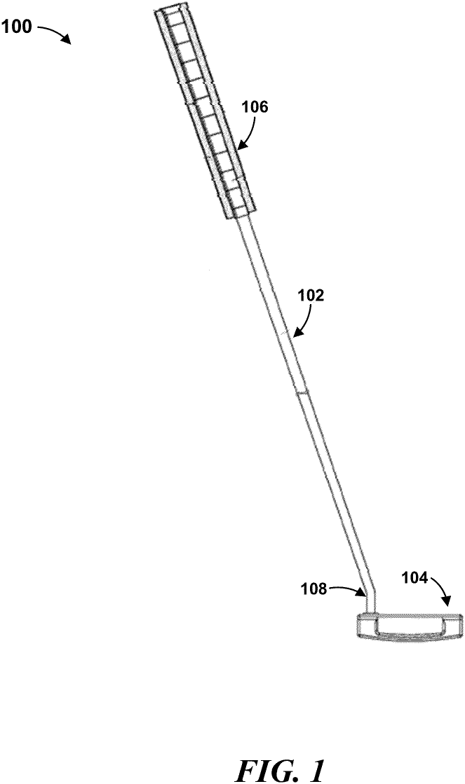

FIG. 1 is a diagram illustrating a putter 100, in accordance with aspects of the disclosure. The putter 100 has a shaft 102, a club head 104, a grip 106, and a hosel 108. The shaft 102 may be tapered and hollow and may be made of a homogenous material, such as steel, or a carbon fiber composite, known as graphite. The shaft may have a steel core in the tip section only, or tip and mid-section, or the entire shaft length may be a homogeneous steel core. The shaft 102 may be a multi-material shaft composed of composite materials and steel and may be composed of a steel tip or a steel mid-section. The shaft 102 may be described in terms of a shaft flex. The shaft flex is the amount that the shaft will bend when placed under load, which occurs during putting. A stiffer shaft may not flex much and may involve more power during the golfer’s swing, producing a higher club speed at ball impact. In contrast, a more flexible shaft may flex more and may involve less power, however, the shaft may torque and over-flex if swung with excessive power, causing the head to not be square at ball impact. Most shaft manufacturers offer a variety of flexes in shafts, to allow golfers to select the most suitable shaft for their game and ability. The shaft 102 may be bent near the club head mounting to provide a lie and club head position that places the line of the straight portion of the shaft 102 at the “sweet” or preferred spot of the subhead of the club head, where the ball should be for a more accurate put.

The shaft 102 is attached or coupled to the club head 104 using a hosel 108 or may be bonded to a putter head having a stud in place of a hosel 108. The hosel 108 may also be offset to place the shaft 102 of the putter 100 in line with the center of the ball at impact. The shaft 102 thus points directly into the center of the ball at impact. The hosel 108 extends from the club head 104 and into the shaft 102 and may not be externally visible. The hosel 108 affects the balance, feel, and power of the putter 100. The hosel 108 assists in placing minimum mass over the top of the striking face of club head 104, thus lowering the center of gravity of the putter 100.

The club head 104 may have a shorter, thicker head that may be slightly curved from front to rear. This design places the majority of the mass behind the club face and as low as possible. In addition, the club head 104 may incorporate peripheral weighting to increase the moment of inertia of the club head 104 to reduce twisting if the putter 100 contacts the ball slightly off-center. The club head 104 may be of multiple styles including mallet, peripheral weighted, and blade.

The shaft 102 has a grip 106 at one end, opposite the club head 104. The grip 106 may be wrapped leather or a one-piece sleeve made of rubber, synthetic, or composite material that is slid over the shaft 102 and may be secured with an adhesive. The grip 106 allows a player to customize the diameter, consistency, and texturing pattern for a better fit. The grip 106 may have any cross-section that is symmetrical along the length of the grip 106 through at least one plane. A “shield” profile with a flat top and a curved underside may be used. The grip 106 may taper from thick to thin but may not have thinner sections surrounded by thicker sections (known as “waisting”) and may not have thicker sections surrounded by thinner sections (known as “bulges”).

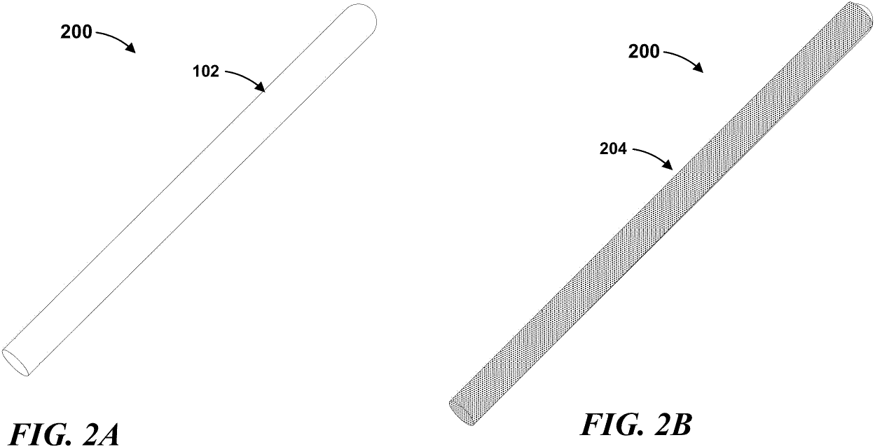

FIG. 2A illustrates shaft fabrication, in accordance with various aspects of the present disclosure. A shaft assembly 200 begins with a shaft 102, which may be steel. The shaft 102 may be hollow and may fabricated from a homogeneous material such as steel, titanium, aluminum, or magnesium with a tip inside diameter that may range from 0.300 inches up to and including, but not exceeding 0.500 inches. The tip outside diameter may be at least 0.350 inches.

FIG. 2B illustrates further shaft fabrication, in accordance with various aspects of the present disclosure. In the aspect shown in FIG. 2B the full length of the shaft 102 may be a hollow shaft, however, other aspects, discussed in detail below, may have a metal tube for a portion of the length of the shaft 102. The surface of shaft 102 may be a rough sanded surface that may be cleaned using a solvent, such as acetone. As shown in FIG. 2B, the entire length of the shaft 102 may be a rough sanded surface 204.

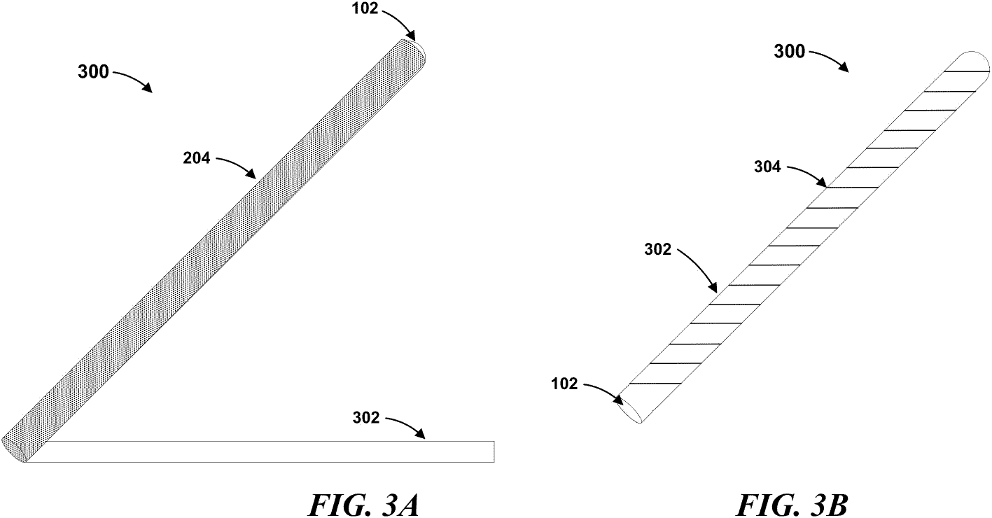

FIG. 3A depicts further shaft fabrication, in accordance with various aspects of the present disclosure. The shaft assembly 300 of FIG. 3A has the shaft 102 prepared for further fabrication by a rough sanding and/or cleaning to produce the rough sanded surface 204 of the shaft 102. An adhesive layer 302 is applied to the shaft 102. Alternatively, the adhesive layer 302 may be applied to a pre-preg layer of a composite material. Pre-preg material is a composite material made from pre-impregnated fibers and a partially cured polymer matrix, such as epoxy, phenolic resin, or thermoplastic mixed with liquid rubbers or resins. The pre-preg layer of composite material may compose carbon fiber, fiberglass fiber, boron, Kevlar and other fibers commonly used in the fabrication of composite golf shafts. The adhesive layer 302 uses a viscoelastic adhesive. The composite material, which may be referred to as a pre-preg material 304, and may comprise pre-impregnated fibers, and a partially cured polymer matrix and may have a thickness from 0.001 inches to 0.0200 inches. The tensile modulus of the composite may be between 10,500 ksi to 135 msi. The partially cured polymer matrix may be epoxy or phenolic resin, or may be thermoplastic mixed with liquid rubbers or resins. The fibers often take the form of a weave and the matrix bonds the fibers and the polymer matrix together. The thermoset matrix may be partially cured for ease of handling. The partially cured polymer matrix may be one of epoxy material, phenolic resin, or a thermoplastic mixed with liquid rubber or resin. The rough sanded surface 204 will have a first layer of pre-preg material 304 applied using adhesive layer 302. The first layer of pre-preg material 304 may be wound around the shaft 102 at a desired angle.

FIG. 3B depicts further shaft fabrication, in accordance with various aspects of the present disclosure. After a first layer of pre-preg material 304 is rolled onto the shaft 102, the shaft assembly 300 appears as shown in FIG. 3B. The pre-preg material 304 may comprise the composite material or pre-preg material 304 may also be applied by other manufacturing methods such as filament winding, resin transfer molding, vacuum molding, compression molding or other suitable methods.

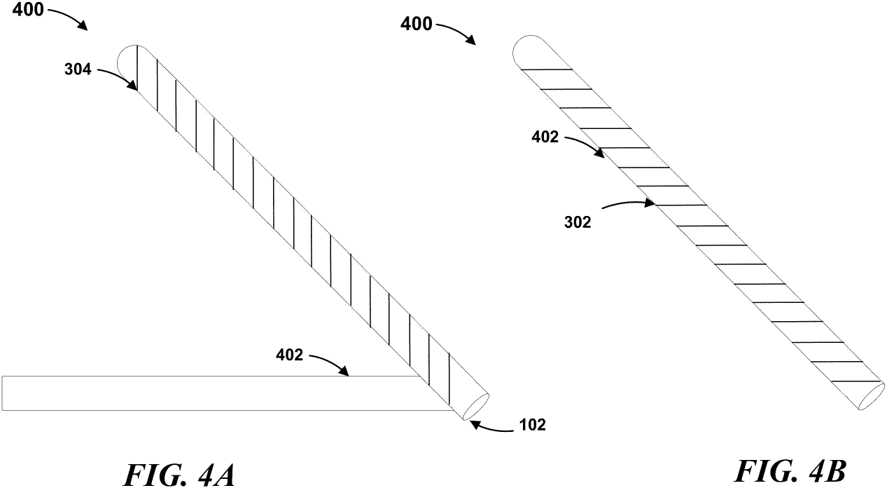

FIG. 4A illustrates further shaft fabrication, in accordance with various aspects of the present disclosure. The shaft assembly 400 may have additional layers of pre-preg material rolled onto the shaft 102, with up to ten layers of pre-preg material applied. As shown in FIG. 4A, a second layer of pre-preg material 402 is also applied to the shaft 102 having first layer of pre-preg material 304 already applied using the same process as described above with respect to FIG. 3B. The adhesive layer 302 is first applied to the first layer of pre-preg material 304 and then the second layer of pre-preg material 402 is rolled onto the shaft assembly 300.

FIG. 4B illustrates further shaft fabrication, in accordance with various aspects of the present disclosure. After the second layer of pre-preg material 402 has been applied, the shaft assembly 400 has a second layer of pre-preg material 402 applied on top of the first layer of pre-preg material 304. Additional layers of pre-preg material may be applied, depending on the desired shaft flex and strength. Each additional layer of the pre-preg material 304 is affixed with an additional layer of the adhesive layer 302. After the desired layers of pre-preg material have been applied, a cellophane material is wound onto the shaft assembly 400 to compact the material and function as the exterior mold of the shaft. After the cellophane material has been applied, the shaft assembly 400 is oven cured at the rate and temperature specified by the particular resin system.

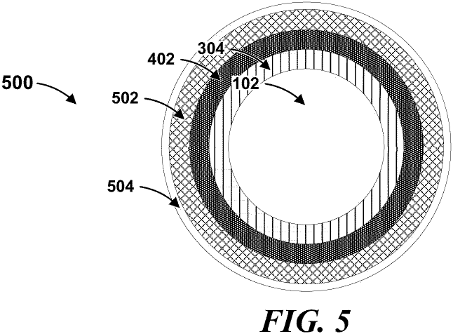

FIG. 5 shows a cross-section of a putter shaft, in accordance with various aspects of the present disclosure. A shaft assembly 500 includes the shaft 102 with the first layer of pre-preg material 304 applied. The first layer of pre-preg material 304 is covered with the second layer of pre-preg material 402. The shaft assembly 500 may have up to ten layers of pre-preg material, and in FIG. 5 a third layer of the pre-preg material 502 is shown applied on top of the second layer of pre-preg material 402. A cellophane layer 504 is applied on top of third layer of the pre-preg material 502.

After oven-curing, the shaft assembly 500 is removed from the oven and the cellophane layer 504 is removed, producing a cured top surface on the shaft assembly 500. Surface sanding may be performed to remove any additional resin on the surface to allow for painting and decoration. The finished shaft assembly has a predetermined tip inside diameter based on the homogeneous tube selected and may be bonded to a putter head that uses a shaft over hosel design. The weight of the putter shaft may be optimized by selecting core materials based on their density and strength in the tip section of the shaft where the putter head stud terminates. The hosel 108 of FIG. 1 extends from the club head 104 and into the shaft 102.

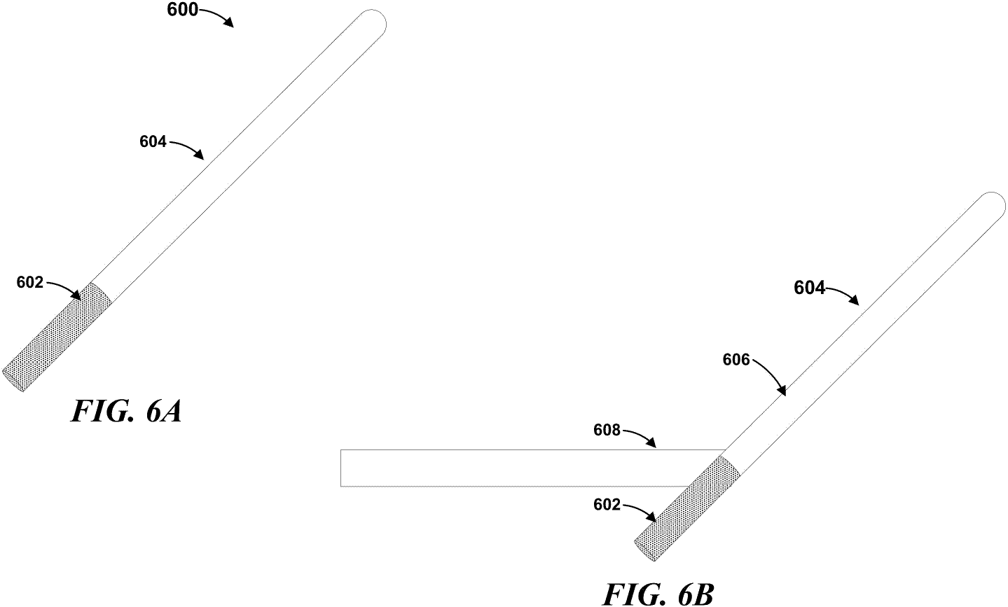

FIG. 6A depicts fabrication of shaft modifications, in accordance with various aspects of the present disclosure. A shaft assembly 600 has a steel or metal section 602 that extends a predetermined length from the tip of the shaft assembly 600. The shaft assembly 600 may be a shaft of composite materials and may incorporate woven and steel. The metal core may be used in the tip section only, providing a steel tip, or may extend further up into a mid-section of the shaft assembly 600. The metal section 602 may be steel, aluminum, titanium, magnesium, or other alloy materials. The adhesive layer applied to the homogeneous core provides both a bonding agent for the composite prepreg as well as the soft “feel” due to its damping characteristics. The remainder of the shaft may be made of composite materials 604. The composite pre-preg material 604 may be selected on the basis of desired material properties such as flex strength, modulus, swing weight, or similar. The tensile modulus of the fibers used may range from 10,500 ksi to 135 msi.

FIG. 6B depicts fabrication of shaft modifications, in accordance with various aspects of the present disclosure. Both the metal section 602 and the viscoelastic material 604 section may be wrapped with a composite ply layer 608, applied with an adhesive 606 to cover both the metal section 602 and the viscoelastic material 604 section.

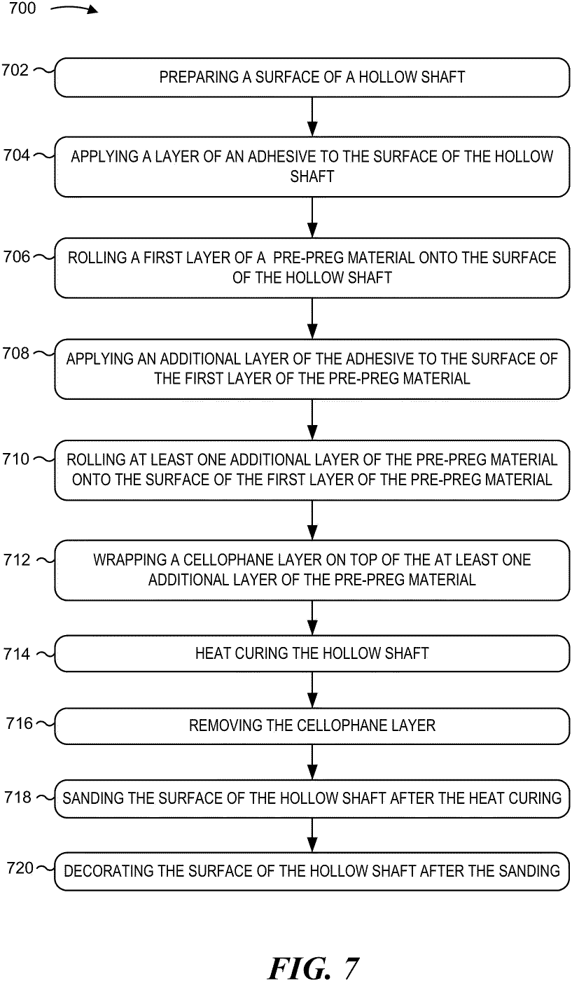

FIG. 7 is a flow diagram illustrating a method of manufacturing a putter shaft, in accordance with various aspects of the present disclosure. The method 700 provides a method of making a golf club shaft. The method begins in block 702 with preparing a surface of a hollow shaft. The hollow shaft may be the shaft 102 of FIG. 1. The hollow shaft may be made of a homogeneous material such as steel, titanium, aluminum, or magnesium with an inside diameter that may range between 0.300 inches to 0.500 inches, without exceeding 0.500 inches. The outside diameter of the hollow shaft (e.g., shaft 102) may be at least 0.350 inches. The surface of the hollow shaft (e.g., shaft 102) may be prepared by rough sanding followed by a thorough cleansing. The cleansing may use acetone or other solvent.

After rough sanding and cleansing the rough sanded surface 204 of the shaft 120 of FIG. 2 is ready for the application of multiple layers of pre-preg material 304 as shown in FIG. 3A. The process continues, in block 704, with applying a layer of adhesive to the surface of the hollow shaft. Then, in block 706, the process continues with rolling a first layer of the pre-preg material onto the surface of the hollow shaft, as shown in FIG. 3B. Then, in block 708, the process continues with applying an additional layer of the adhesive to the surface of the first layer of the pre-preg material. Then in block 710, the process continues with rolling at least one additional layer of the pre-preg material onto the surface of the hollow shaft, as shown in FIG. 4A. The rolling of at least one additional layer of pre-preg material 402 may be in a direction and angle different from that of the first layer. The pre-preg material may be woven. Additional layers of the pre-preg material 402, ranging up to ten layers total, may be added as desired for flex tailoring. In addition, the at least one additional layer of pre-preg material 402 may be a different material than the first layer of pre-preg material 304.

In block 712 the processing continues with wrapping a cellophane layer on top of the at least one additional layer of the pre-preg material. As shown in FIG. 5. the cellophane layer 504 compacts the pre-preg material and acts as the exterior mold. Then in block 714, heat curing the hollow shaft occurs. The cure cycle rate and temperature is selected based on the pre-preg material rolled onto the hollow shaft in blocks 706 and 710. Next, in block 716, removing the cellophane layer occurs. Sanding the surface of the hollow shaft takes place in block 718. In block 720 decorating the surface of the hollow shaft is performed. The surface of the third layer of the pre-preg material 502 may be decorated with manufacturer’s logos or other decorative elements.

The resulting shaft has a predetermined tip inside diameter that is based upon the homogeneous tube chosen. The shaft may be bonded to a putter head or club head 104 that uses shaft over hosel design. The designer may tune the shaft weight by selecting different density core materials. The core material may also be selected based on the specified strength in the tip section of the shaft where the putter head stud terminates. In addition, the shaft flex may be adjusted by careful selection of the pre-preg materials for modulus permits tuning the stiffness of the shaft. Incorporating the composite materials into the shaft design provides vibration damping as well as structural stiffness and strength.

Aspects of the disclosure provide a club shaft that may use composite materials where specified to deliver the desired stiffness and feeling. In addition, the composite materials in conjunction with the homogeneous material provide improved durability and damping characteristics.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

What is claimed is:

1. A golf club shaft, comprising:
a hollow shaft including a sanded and cleaned surface;
a first layer of a pre-preg material rolled onto the hollow shaft and secured to the hollow shaft using an adhesive layer; and
at least one additional layer of the pre-preg material rolled onto the first layer of the pre-preg material on the hollow shaft and secured to the hollow shaft using the adhesive layer.

2. The golf club shaft of claim 1, in which the hollow shaft comprises a homogeneous material.

3. The golf club shaft of claim 2, in which the homogeneous material is selected from: steel, titanium, aluminum, and magnesium.

4. The golf club shaft of claim 1, in which the adhesive layer and the first layer of the pre-preg material are of similar thickness.

5. The golf club shaft of claim 1, in which one to ten layers of the pre-preg material are applied to the hollow shaft.

6. The golf club shaft of claim 1, in which the hollow shaft has a tip inside diameter ranging between 0.300 inches and 0.500 inches.

7. The golf club shaft of claim 1, in which the pre-preg material has a thickness between 0.001 inches and 0.020 inches.

8. A method of manufacturing a golf club shaft, comprising:
preparing a surface of a hollow shaft;
applying a layer of an adhesive to the surface of the hollow shaft;
rolling a first layer of a pre-preg material onto the surface of the hollow shaft;
applying an additional layer of the adhesive to the surface of the first layer of the pre-preg material;
rolling at least one additional layer of the pre-preg material onto the surface of the first layer of the pre-preg material;
wrapping a cellophane layer on top of the at least one additional layer of the pre-preg material;
heat curing the hollow shaft;
removing the cellophane layer;
sanding the surface of the hollow shaft after the heat curing; and
decorating the surface of the hollow shaft after the sanding.

9. The method of claim 8, further comprising applying the adhesive to the at least one additional layer of the pre-preg material.

10. The method of claim 9, further comprising applying the at least one additional layer of the pre-preg material onto the surface of the hollow shaft.

11. The method of claim 10, further comprising applying the adhesive and additional layers of the pre-preg material.

12. The method of claim 11, in which up to ten additional layers of the pre-preg material are applied.

13. The method of claim 8, in which the pre-preg material comprises carbon fiber.

14. The method of claim 8, in which the adhesive is a viscoelastic material.

15. The method of claim 8, in which the pre-preg material comprises pre-impregnated fibers and a partially cured polymer matrix.

16. The method of claim 15, in which the partially cured polymer matrix is one of: epoxy material, phenolic resin, thermoplastic mixed with liquid rubber or resin.

17. The method of claim 15, in which the pre-impregnated fibers are woven and a matrix bonds the pre-impregnated fibers in the matrix together.

18. A putter, comprising:
a shaft of composite materials;
a putter head having a stud for mounting to the shaft of composite materials; and
a grip affixed to the shaft of composite materials.

19. The putter of claim 18, in which the shaft of composite materials has a steel tip coupled with the composite materials.

20. The putter of claim 18, in which the shaft of composite materials has a steel mid-section coupled with the composite materials.
